(19) United States
(12) Patent Application Publication
(10) Pub. No.: US 2008/0185223 A1
(43) Pub. Date: Aug. 7, 2008

(54) Step Ladder

(76) Inventor: Gunnar Lem, Oslo (NO)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/570,401

(22) PCT Filed: Dec. 22, 2005
(86) PCT No.: PCT/NO2005/000201

§ 371 Date: Nov. 14, 2007

(30) Foreign Application Priority Data
Jun. 11, 2004 (NO) 20042446
Aug. 17, 2004 (NO) 20043427

(51) Int. Cl. E06C 1/39

(52) U.S. Cl. 182/116

(57) ABSTRACT

A step or rung ladder is disclosed, which can be folded together into a compact unit under transport. The step or rung ladder includes two step frame sections (1, 2) connected by lockable hinges (3, 3′), and two support frame sections (9, 6) also connected by lockable hinges (8, 8′). The step frame is connected to the support frame in its upper end by hinges (15, 15′). A support or safety rail is connected to the upper end of the step frame, either rigidly or by a third set of lockable hinges (10, 10′).

### FIELD OF THE INVENTION

The present invention relates to a so-called step ladder that is particularly suited for craftsmen or workmen in general.

### BACKGROUND OF THE INVENTION

Step ladders are free-standing ladders that can be erected without support from a wall, and can be folded together under transport. A step ladder consists of a step frame which is pivotally attached to a smaller support frame. The step frame includes a number of rungs, or steps. Steps are climbing supports with “walking surfaces” typically 8 cm deep or more, while rungs have less deep “walking surfaces”, typically 2-5 cm. In this document steps and step ladder will respectively mean steps or rungs and step ladder or rung ladder. The upper step is often a step-plate or platform, enabling a user to stand and move safely and comfortable. The step and support frames are connected by some locking mechanism that prevents the step ladder from collapsing. At its upper end the step ladder as described above can be extended vertically into a support rail, also called a safety rail; said rail giving support to the user climbing the step-ladder, and acting as a safety rail allowing the user to recover balance when lightly destabilised. A small tray, sometimes called a utility tray, may be fastened to the support rail for holding tools etc. The platform in combination with the support rail allows the user to utilize all steps of the step ladder gaining at least one additional step compared with a conventional ladder.

Step ladders have definite advantages as they are lightweight, commonly made from aluminium, and easy to erect due to the uncomplicated locking mechanism. Another advantage with the step ladder is that it is free standing and can be erected at the middle of a room, e.g. when mounting a bracket or lamp in the ceiling. Still another advantage is that the steps can be very broad and flat, thus allowing extended work in safe and more ergonomically conditions.

Step ladders are popular with craftsmen, such as electricians, and they often bring with them step ladders when visiting customers or construction sites. Small step ladders can be transported inside a van, as long as they do not include a safety rail. Such step ladders are described with different unfolding solutions for broad and practical steps in U.S. Pat. No. 6,347,687 or with narrow steps as described in WO03014516A1. However, step ladders with more steps (more than four) are considered as more practical by craftsmen, especially to reach higher ceilings such as those in commercial and industrial buildings. To the length of the frames, one has to add the safety rail, leading to a significant overall length. Thus, larger step ladders with a safety rail and/or more than four-to-five to eight steps must be transported on the rooftop, as they are too large to fit inside small vans. Such solutions are described in US2004/0007424A1. Note that the safety rail can be also used to support a utility tray, an interesting feature to avoid time-consuming climbing up and down the step ladder. A well developed example is in the later patent application.

A compact alternative that can be transported in a car is the common foldable extension ladder. This is an aluminium construction made from four section ladders joined by six steel locking hinges allowing three rotation axes. This extension ladder has its advantages, as it is compact when folded together and can be expanded into several configurations. However, this is a rather heavy construction, as the section ladders must be of sturdy dimensions in order to provide the necessary structural integrity, especially when meant for professional use. Additionally, the large number of locking hinges, each with several locking positions, means that the ladder is more complicated to mount.

U.S. Pat. No. 5,163,532 describes a conventional extension ladder with locking hinges of a master/slave variety permitting the locks to be operated from only one side of the ladder.

Locking hinges for folding ladders are disclosed in U.S. Pat. No. 4,824,278 and U.S. Pat. No. 6,711,780. In U.S. Pat. No. 4,824,278 the lock is operated with a lever, while the lock in U.S. Pat. No. 6,711,780 is operated with a knob on the outer of the lock mechanism.

In recent years telescopic ladders have come to the market, such as the one described in WO02101189A1. These ladders are both relatively lightweight and compact when collapsed. However, the telescopic mechanism is complicated and includes a large number of components. The ladder feels unsteady due to the many joints in the telescopic mechanism. This mechanism is also fragile as it is easily jammed by paint, glue, sand or concrete spilled on the legs, or by a small dent in a leg. These ladders have proved too fragile to stand the exhaustive use by craftsmen, and have even raised the attention of some national Health and Safety authorities following deficient locking due to particles.

U.S. Pat. No. 4,520,896 describes a foldable ladder including a lower step section connected to a strut. The lower step section is further connected to a lower step section in a lockable pivot located in the connection between the lower step section and the strut. The upper step section may be folded along the lower step section. However, this construction is unstable as the steps in the upper step section are located above the point of support where the lower step section is connected to the strut. Thus, it is dangerous to climb the upper step section.

U.S. Pat. No. 6,651,774 describes a stepladder with a foldable support rail. However, this support rail is not locked in any way when erected, and can thus not give support to a user, e.g. if he accidentally steps backwards. The support rail is evidently only intended to support a tool tray in a high position easily accessible for the user.

Different extensions to ladders have also been devised, such as those to allow installation on stairs or uneven surfaces, as for instance in EP00047151A3 or U.S. Pat. No. 4,671,383. Less sophisticated extension legs levellers can be found on the market, as free extensions, as a fully integrated part of the ladder (telescopic solution), or as an add-on built-in part for simpler mechanical solutions. Extension legs (or leg levellers) tend to create problems for craftsmen: when those are not incorporated as an integrated part of the ladder, workers must track down the legs all over the construction site, resulting in waste of time. Often this ends up with having to buy new (and quite expensive) ones.

Health and Safety regulations in several countries now request that ladders for professional use shall support minimum loads, for instance 150 kg in the European Union. This requirement means that the ladders tend to become heavy and impractical for craftsmen, who need the ladders as light as possible.

### BRIEF SUMMARY OF THE INVENTION

Therefore, it is an object of the present invention to provide a step ladder that is of a size, robustness and safety suited for the needs of craftsmen while it easily can be transported inside a car.

Another object is to provide a step ladder with the above mentioned features and being equipped with a support rail and a utility tray.

Still another object is to provide a step ladder with the above mentioned features and being equipped with built-in leg levellers.

Other objects are to provide a step ladder that is easily collapsed into a compact unit, while it is easy to mount and can be mounted on an uneven support, like in stairs.

The objects above are achieved in a step ladder as claimed in the appended patent claims. In particular, the inventive step-ladder includes step and support frames that are each foldable, as well as a support rail that may be foldable as well. In addition, the folding mechanism may include hinges with a single locking position. Some, or all, of the legs may be equipped with an extension mechanism, e.g. an extension leg or a telescopic leg.

The invention will now be described in detail in reference to the appended drawings.

### BRIEF DESCRIPTION OF THE DRAWINGS

FIG. 1 shows the inventive step-ladder mounted,

FIG. 2 shows the ladder when folded together,

FIG. 3 shows a detail of the inventive step ladder with an improved hinge mechanism, while

FIG. 4 shows another hinge mechanism.

FIG. 5 shows an embodiment of the invention with a simplified construction.

### DETAILED DESCRIPTION OF THE INVENTION

The ladder includes a step frame composed of first 1 and second 2 step sections, each including a pair of side rails and a number of spaced rungs. The step sections 1, 2 are joined by locking hinges 3, 3′. The locking mechanism may be released with a knob or handle on the hinge. In order to provide a step ladder that is easy to erect and collapse, the hinges should have a limited number of locking positions, e.g. only one, or possibly an additional locking position that is engaged when the sections are folded together. Further, the step ladder could be provided with locking hinges of the master/slave type, as exemplified in U.S. Pat. No. 5,163,532. The ladder can also be provided with push rods or wires connecting the release mechanisms in the hinges allowing all hinges to be released concurrently from a central position.

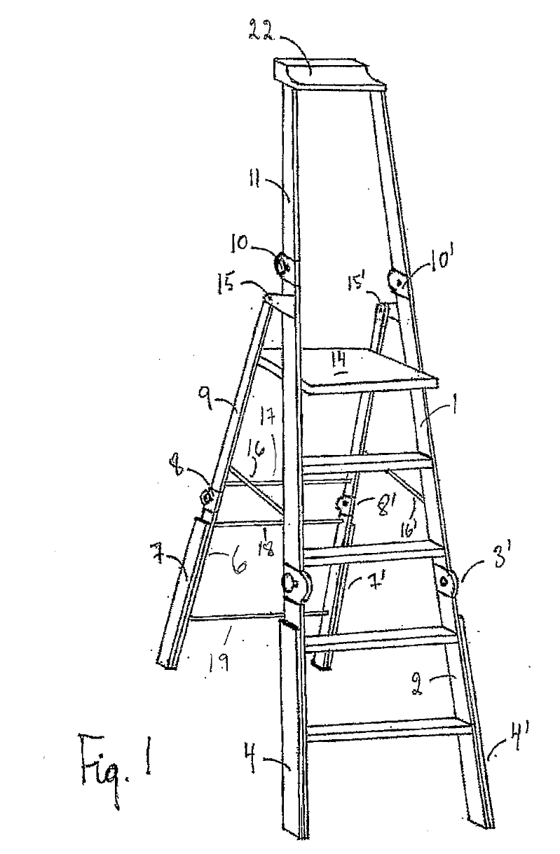

The first step frame is pivotally connected to a support frame in hinges 15, 15′. The support frame is composed of first support section 9 which is joined to a second support section 6 by locking hinges 8, 8′. When the step ladder is mounted, the frames are swung out around the hinges 15, 15′ and locked together in this position (as shown in FIG. 1) by a platform 14, and possibly crossbars or straps 16, 16′. The support sections 9, 6 should include at least one cross strut 17, 18, 19, in order to provide structural integrity.

A support rail 11 is connected to the first step section 1 as an extension of said first step section 1. The support rail 11 is connected to the first step section 1 by two lockable hinges 10, 10′. When the locks are released, the support rail 11 can be folded backwards (alternatively forwards, see later) from the first step section 1. The support rail 11 may carry a small tool tray 22 which also serve as a point of support for a user climbing the step ladder.

All legs are equipped with extension legs 4, 4′, 7, 7′. In the figure this is shown as short bars slideable connected to each leg. However, other extension mechanisms could be envisaged, such as extension pins or telescopic legs.

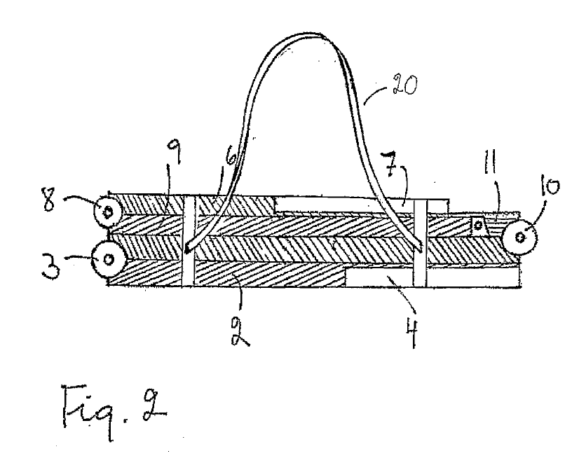

FIG. 2 shows the inventive step ladder in a collapsed state. When collapsing the step ladder, the sections 1, 2 and 9, 6 must be closed together in the hinges 15, 15′. Then, the frame 2 is folded forward towards the frame 1. The support rail 11 is folded backwards against the support frames 9, 6, and the support frame 6 is folded by the hinges 8, 8′ onto the frame 9 and support rail 11. Then, the collapsing process is completed. A shoulder strap 20 makes the ladder easier to carry.

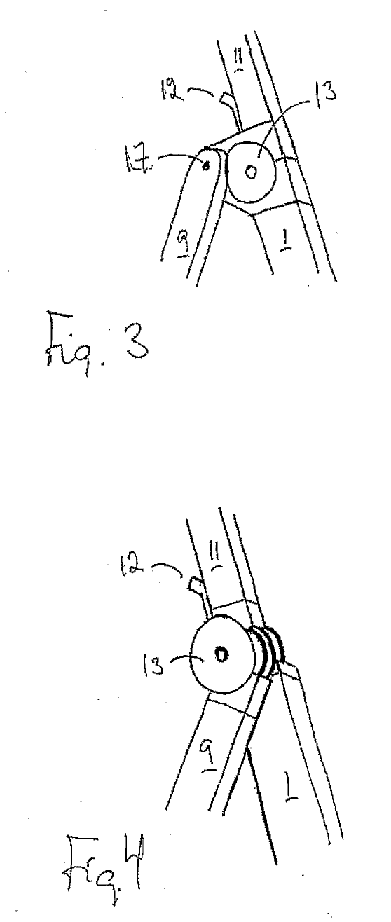

FIG. 3 shows a detail of an embodiment of the step ladder, in which the hinges between the support rail 11, the step frame 1 and the support frame 9 has been combined into one unit 13 replacing the components designated 10 and 15 in FIG. 1. The unit 13 includes a locking hinge between the step frame 1 and the support rail 11. This lock is operated with a release lever 12. The bracket mounting the hinge unit 13 to the step frame 1 has been expanded to accommodate a non-locking hinge 17 supporting the support frame 9.

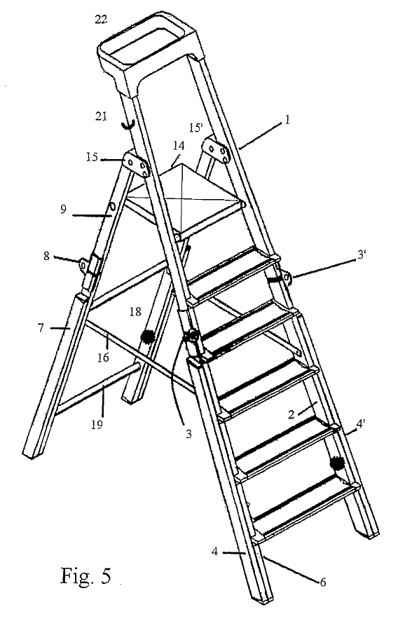

While FIG. 1-3 all shows the support rail being connected to the step frame 1; it could as well be connected to the support frame 9, either in a separate hinge, or as illustrated in FIG. 4. Here the hinge unit 13 incorporates a three way locking hinge. The support rail is connected to the support frame 9 instead of the step frame 1. The step frame 1 is then connected to an additional deck in the locking hinge inside the main body of the hinge. This last deck can be independent of the locking mechanism, i.e. non-locking.

While the embodiments shown all comprises a support rail that is folded towards the support frame when collapsing the step ladder, it is also possible to devise a step ladder in which h the support rail is folded the other way around, i.e. towards the step frame when collapsing the step ladder.

FIG. 5 shows a step ladder of a simplified construction. The ladder includes first and second step frames 1, 2 joined by first locking hinges 3, 3′, and first and second support frames 9, 6 joined by second locking hinges 8, 8′. The step frames and support frames are joined in third hinges 15, 15′, and held together by straps 16, 16′. The straps could be replaced with crossbars. If crossbars are used, they should be pivotally connected to the frames, and slide in slots in one of the frames (not shown). A number of cross struts 17, 18, 19 have been included.

The legs include extension legs 4, 4′, 7, 7′. However, it may be unnecessary to include extension legs for all legs as shown in the figure; normally it will suffice to include one or two extension legs.

Contrary to the step ladder shown in FIG. 1, in this step ladder the support rail is not a separate unit pivotally connected to the first ladder frame, but is a fixed extension of said frame. This saves a hinge set, and makes the ladder easier to mount and collapse. In such a construction, the first and second step frames should be of similar lengths. When collapsed, the ladder in FIG. 5 will not be as compact as the ladder shown in FIG. 1, but the construction will be appreciable simplified.

The support rail carries a tool tray 22. The tool tray is exchangeable, e.g. by being snapped onto the ends of the frame, or by forming a tray holding a tool insert. In this way, different tool trays may be offered, which are customized to the needs of the user, i.e. trays designed to maximize utilisation for different professionals. The tray may e.g. be particularly adapted to hold the pliers, screwdrivers, measuring instruments and other particular tools of an electrician. Other trays may be designed to hold a painter's utensils, or the tools used by cleaners, carpenters, etc. A given user may even have several tray embodiments, which he may install according to the need of the situation. The tool trays may be produced in plastic or metal. In addition, a hook 21 is shown mounted to the upper end of the first ladder frame 1. A similar hook may be mounted on the other side of the ladder.

The ladders shown in FIGS. 1 and 5 include four steps and a platform 14 of plastic or metal. However, the ladders may include any number of steps as desired, say 8, 10 or even more.

1. A step ladder or rung ladder including a step frame and a support frame, a platform (14) connecting said first step frame and said first support frame,
characterized in said step frame including a first step section (1) with a first end and a second end, said first step section (1) including a number of steps or rungs, and a second step section (2) with a first end and a second end, said second step section including a number of steps or rungs,
a first set of lockable hinges (3, 3′) connecting the second end of said first step section (1) with the first end of said second step section (2),
said support frame including a first support section (9) with a first and a second end, and a second support section (6) with a first and a second end,
a second set of lockable hinges (8, 8′) connecting the second end of said first support section (9) with the first end of said second support section (6),
said ladder further including a third set of hinges (15, 15′) connecting the first end of said first support section (9) to the first step section (1) in a point near the first end of the first step section (1),
a support rail (11) arranged as a fixed extension of said step frame , wherein said support rail (11) is supported in a support axis located in said third set of hinges (15, 15′) and may turn about a rotation axis located in said first set of lockable hinges (3, 3′), said rotation axis being located below said support axis.

2. A step ladder or rung ladder as claimed in claim 1, in which said first and second set of hinges have but a single locking position.

3. A step ladder or rung ladder as claimed in claim 1, in which said first and second set of hinges are mutually connected allowing all hinges to be released from a central position.

4. A step ladder or rung ladder as claimed in claim 1, said ladder including a tool tray (22) mounted on said support rail, said tool tray being releasable mounted on the support rail.

5. A step ladder or rung ladder as claimed in claim 1, including at least one extension leg (4, 4′, 7, 7′) at the second end of the second step section (2) and/or at the second end of the second support section (6).

6. A step ladder or rung ladder including a step frame and a support frame, a platform (14) connecting said first step frame and said first support frame,
characterized in said step frame including a first step section (1) with a first end and a second end, said first step section (1) including a number of steps or rungs, and a second step section (2) with a first end and a second end, said second step section including a number of steps or rungs,
a first set of lockable hinges (3, 3′) connecting the second end of said first step section (1) with the first end of said second step section (2),
said support frame including a first support section (9) with a first and a second end, and a second support section (6) with a first and a second end,
a second set of lockable hinges (8, 8′) connecting the second end of said first support section (9) with the first end of said second support section (6),
said ladder further including a third set of hinges (15, 15′) connecting the first end of said first support section (9) to the first step section (1) in a point near the first end of the first step section (1),
a support rail (11) connected to said first step section (1) or said first support section (9) in said third hinges (13, 13′) or in fourth lockable hinges (10, 10′).

7. A step ladder as claimed in claim 6, including a tool tray (12) at the first end of the support rail (11).

8. A step ladder as claimed in claim 6, including extension legs (4, 4′, 7, 7′) at the second end of the second step section (2) and at the second end of the second support section (6).

9. A step ladder as claimed in claim 6, in which said first, second and third locking hinges have but a single locking position.

10. A step ladder as claimed in claim 6, in which said first, second and third locking hinges are mutually connected allowing all hinges to be released from a central position.
